(19) United States
(12) Patent Application Publication
(10) Pub. No.: US 2007/0039820 A1
(43) Pub. Date: Feb. 22, 2007

(54) Sensing element with a protective layer having a gas exchange region and a method of making the same

(76) Inventors: Eric P. Clyde, Bay City, MI (US); Jo-Ann S. Novak, Oxford, MI (US); Mark Jones, Goodrich, MI (US)

Correspondence Address: Jimmy L. Funke;Delphi Technologies, Inc., Mail Code: 480-410-202, P.O.Box 5052, Troy, MI, 48007-5052, US

(21) Appl. No.: 11/206,544

(22) Filed: Aug. 18, 2005

(51) Int. Cl. G01N 27/26

(52) U.S. Cl. 204/400

(57) ABSTRACT

Disclosed herein is a sensing element with a sensing electrode, a reference electrode; and an electrolyte disposed between and in ionic communication with the sensing electrode and the reference electrode. A protective layer is disposed adjacent to the sensing electrode. A plurality of vias is disposed in the protective layer adjacent to the electrolyte and in fluid communication with the sensing electrode and a gas to be sensed. The vias have a diameter of about 50 micrometers to about 250 micrometers.

### TECHNICAL FIELD

The present disclosure is related to a sensing element comprising a protective layer with a gas exchange region and a method of making the same.

### BACKGROUND

The automotive industry has used exhaust gas sensors in vehicles for many years to sense the composition of exhaust gases, namely, oxygen. For example, a sensor is used to determine the exhaust gas content for alteration and optimization of the air to fuel ratio for combustion.

One type of sensor uses an ionically conductive solid electrolyte between porous electrodes. For oxygen, solid electrolyte sensors are used to measure oxygen activity differences between an unknown gas sample and a known gas sample. In the use of a sensor for automotive exhaust, the unknown gas is exhaust and the known gas, (i.e., reference gas), is usually atmospheric air because the oxygen content in air is relatively constant and readily accessible. This type of sensor is based on an electrochemical galvanic cell operating in a potentiometric mode to detect the relative amounts of oxygen present in an automobile engine's exhaust. When opposite surfaces of this galvanic cell are exposed to different oxygen partial pressures, an electromotive force (“emf”) is developed between the electrodes according to the Nernst equation.

With the Nernst principle, chemical energy is converted into electromotive force. A gas sensor based upon this principle typically includes an ionically conductive solid electrolyte material, a porous electrode with a porous protective overcoat exposed to exhaust gases (“exhaust gas electrode”), and a porous electrode exposed to a known gas' partial pressure (“reference electrode”). Sensors typically used in automotive applications use a yttria stabilized zirconia based electrochemical galvanic cell with porous platinum electrodes, operating in potentiometric mode, to detect the relative amounts of a particular gas, such as oxygen for example, that is present in an automobile engine's exhaust. Also, a typical sensor has a ceramic heater attached to help maintain the sensor's ionic conductivity. When opposite surfaces of the galvanic cell are exposed to different oxygen partial pressures, an electromotive force is developed between the electrodes on the opposite surfaces of the zirconia wall, according to the Nernst equation:

$$E = ( \frac{- RT}{4 F} ) ln ( \frac{{P}_{{O}_{2}}^{ref}}{{P}_{{O}_{2}}} )$$

where:
E=electromotive force
R=universal gas constant
F=Faraday constant
T=absolute temperature of the gas
p_{O}_{₂}^{ref}=oxygen partial pressure of the reference gas
p_{O}_{₂}=oxygen partial pressure of the exhaust gas

Due to the large difference in oxygen partial pressure between fuel rich and fuel lean exhaust conditions, the electromotive force (emf) changes sharply at the stoichiometric point, giving rise to the characteristic switching behavior of these sensors. Consequently, these potentiometric oxygen sensors indicate qualitatively whether the engine is operating fuel-rich or fuel-lean, conditions without quantifying the actual air-to-fuel ratio of the exhaust mixture. For example, an oxygen sensor, with a solid oxide electrolyte such as zirconia, measures the oxygen activity difference between an unknown gas and a known reference gas. Usually, the known reference gas is the atmosphere air while the unknown gas contains the oxygen with its equilibrium level to be determined. Typically, the sensor has a built in reference gas channel which connects the reference electrode to the ambient air.

Some sensing elements include a protective layer with a gas exchange region, adjacent to the sensing electrode. The gas exchange region can comprise a porous ceramic material, which permits the exchange of gas through the protective layer to the sensing element.

There is a need in the art for an improved gas exchange region and a method of making.

### SUMMARY

Disclosed herein in one embodiment is a sensing element comprising: a sensing electrode; a reference electrode [14]; and an electrolyte [L2] disposed between and in ionic communication with the sensing electrode [12] and the reference electrode [14]; a protective layer [L1] disposed adjacent to the sensing electrode [12]; and a plurality of vias [22] disposed in the protective layer [L1] adjacent to the electrolyte [L2] and in fluid communication with the sensing electrode [12] and a gas to be sensed.

Also disclosed herein is a method of forming a sensing element [10] comprising: disposing an electrolyte [L2] between and in ionic communication with a sensing electrode [12] and a reference electrode [14]; forming a plurality of vias [22] in an unfired protective layer [L1] and disposing the plurality of vias [22] adjacent to and in fluid communication with the sensing electrode [12]; and heating for a sufficient time and at a sufficient temperature to form the sensing element [10].

The above described and other features are exemplified by the following figures and detailed description.

### BRIEF DESCRIPTION OF THE DRAWINGS

Refer now to the figures, which are exemplary embodiments, and wherein like elements are numbered alike.

FIG. 1 is an exploded perspective view of a sensing element comprising a protective layer with a gas exchange region.

FIG. 2 is a top view of the protective layer shown in FIG. 1, after formation of the vias.

FIG. 3 is a cross-sectional view of the protective layer shown in FIG. 2.

FIG. 4 is a top view of the protective layer shown in FIG. 1, after filling the vias with a porous ceramic material.

FIG. 5 is a cross-sectional view of the protective layer shown in FIG. 4.

FIG. 6 is a cross-sectional view of a portion of the sensing element in FIG. 1.

### DETAILED DESCRIPTION OF INVENTION

At the outset of the detailed description, it should be noted that the terms “first,” “second,” and the like herein do not denote any order or importance, but rather are used to distinguish one element from another, and the terms “a” and “an” herein do not denote a limitation of quantity, but rather denote the presence of at least one of the referenced items. The modifier “about” used in connection with a quantity is inclusive of the stated value and has the meaning dictated by the context (e.g., includes the degree of error associated with measurement of the particular quantity). Unless defined otherwise herein, all percentages herein mean weight percent (“wt. %”). Furthermore, all ranges disclosed herein are inclusive and combinable (e.g., ranges of “up to about 25 weight percent (wt. %), with about 5 wt. % to about 20 wt. % desired, and about 10 wt. % to about 15 wt. % more desired,” are inclusive of the endpoints and all intermediate values of the ranges, e.g., “about 5 wt. % to about 25 wt. %, about 5 wt. % to about 15 wt. %”, etc.). Unless specified otherwise, the term “diameter” refers to the average inner diameter of an opening, as measured along its major axis. Unless specified otherwise, all dimensions disclosed herein are prior to sintering (i.e., in the green state), and are adjusted appropriately for the shrinkage of the parent material utilized; example dimensions are exemplary of products made from material with approximately 18% fired shrinkage). Finally, unless defined otherwise, technical and scientific terms used herein have the same meaning as is commonly understood by one of skill in the art to which this invention belongs.

Disclosed herein is a sensing element comprising a protective layer with a gas exchange region and a method of making the same. The gas exchange region can be formed by forming a plurality of vias in a green (unfired) ceramic material. The vias can be formed using automated equipment, in contrast to other sensing elements, in which the gas exchange region is formed by manually cutting openings, and manually inserting a porous ceramic inserts into the opening. The plurality of vias can be filled with a porous ceramic material, or they can remain unfilled (e.g., void of a filling material).

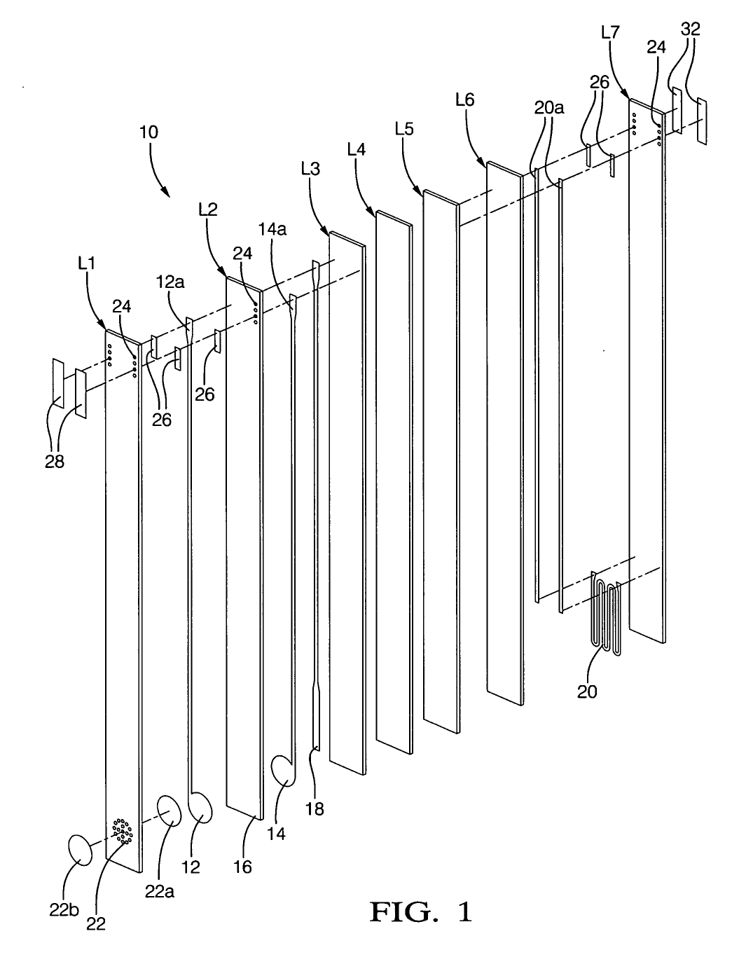

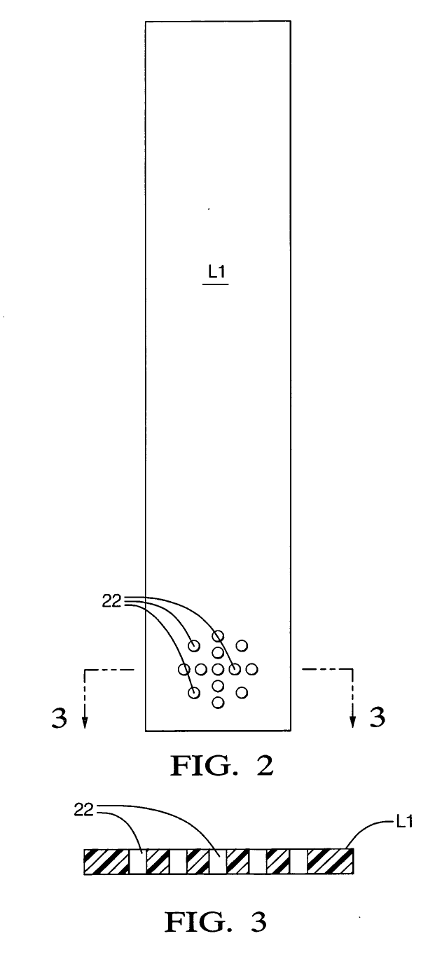

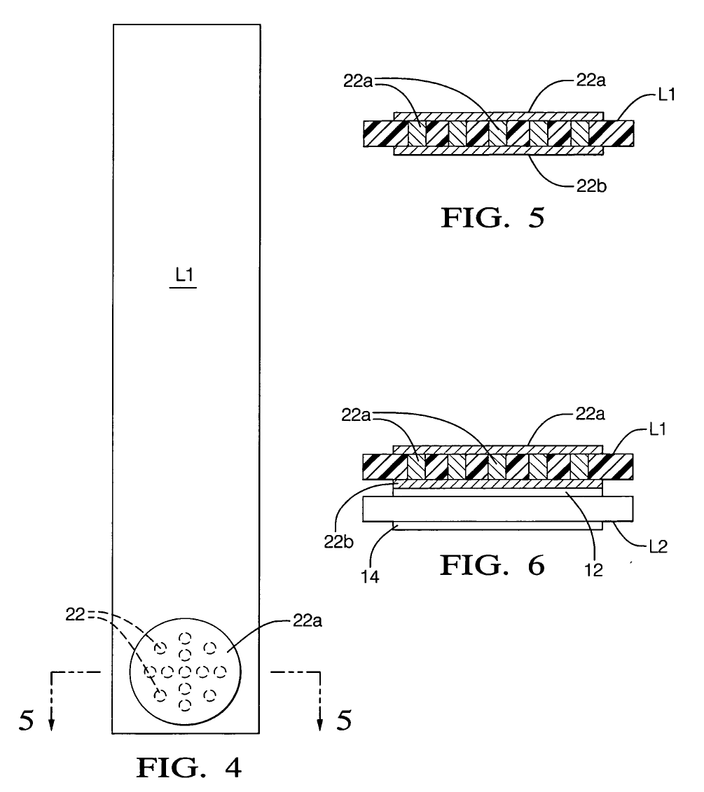

FIGS. 1-6 when taken together illustrate an oxygen sensing element 10. Although described herein in connection with an oxygen sensing element, it is to be understood that the disclosure applies to other sensing elements including gas sensing elements such as nitrogen, hydrogen, hydrocarbon, ammonia and the like. Oxygen sensing element 10 can comprise a plurality of support layers L1 and L3-L7 that can provide structural integrity (e.g., protect various portions of the gas sensor from abrasion and/or vibration, and the like, and provide physical strength to the sensor); physically separate and electrically isolate various components; and provide support for various components that can be formed in or on the layers. The support layers can comprise a dielectric material (e.g., alumina (Al₂O₃), and the like. Each of the support layers can comprise a thickness of about 500 micrometers so, depending upon the number of layers employed, more particularly about 50 micrometers to about 200 micrometers. Although illustrated herein as comprising support layers L1 and L3-L7, it should be understood that the number of layers could be varied depending on a variety of factors.

The sensing element 10 comprises a sensing end 10s and a terminal end 10t, a sensing (i.e., first, exhaust gas or outer) electrode 12, a reference gas (i.e., second or inner) electrode 14, and an electrolyte layer L2. The electrodes 12,14 are disposed on opposite sides of, and in ionic contact with the electrolyte layer L2, thereby creating an electrochemical cell.

Optionally, a reference gas channel 18 can be disposed on the side of the reference electrode 14 opposite the electrolyte layer L2. The reference gas channel 18 can be disposed in fluid communication with the reference electrode 14 and optionally with the ambient atmosphere and/or the exhaust gas.

Also optionally, a heater 20 can be disposed on a side of the reference gas channel 18 opposite the reference electrode 14, for maintaining sensing element 10 at a desired operating temperature. The optional heater 20 can be any heater capable of maintaining the sensor end at a sufficient temperature to facilitate the various electrochemical reactions therein. The heater 20 can be, for example, platinum, aluminum, palladium, and the like, as well as oxides, mixtures, and alloys comprising at least one of the foregoing metals. The heater 20 can be disposed on one of the insulating layers by various methods such as, for example, screen-printing. The thickness of the heater 20 can be about 5 micrometers to about 50 micrometers.

The support layers can comprise a dielectric material (e.g., alumina (Al₂O₃)), and/or an electrolytic material (e.g., zirconia), and the like. Each of the support layers can comprise a thickness of about 500 micrometers so, depending upon the number of layers employed, more particularly about 50 micrometers to about 200 micrometers. Although illustrated herein as comprising seven (7) support layers L1-L7, it should be understood that the number of layers could be varied depending on a variety of factors.

Layer L2 can comprise any material that is capable of permitting the electrochemical transfer of oxygen ions while inhibiting the passage of exhaust gases, should have an ionic/total conductivity ratio of approximately unity, and should be compatible with the environment in which the gas sensor will be utilized (e.g., up to about 1,000° C.). Possible materials for layer L2 can comprise any material capable of functioning as a sensor electrolyte including, but not limited to, zirconium oxide (zirconia), cerium oxide (ceria), calcium oxide, yttrium oxide (yttria), lanthanum oxide, magnesium oxide, ytterbium (III) oxide (Yb₂O₃), scandium oxide (Sc₂O₃), and the like, as well as combinations comprising one or more the foregoing. Zirconia optionally may be stabilized with calcium, barium, yttrium, magnesium, aluminum, lanthanum, cesium, gadolinium, and the like, as well as combinations comprising at least one of the foregoing materials. For example, the electrolyte can be alumina stabilized zirconia and/or yttrium stabilized zirconia.

Optionally, layer L2 can comprise a dielectric material (e.g., alumina) with an electrolyte portion (not illustrated) attached at the sensing end such that it forms the sensing end 10s of layer L2. Also optionally, layer L2 can comprise a porous insert (not illustrated) disposed in an aperture (not illustrated) adjacent to the sensing end 10s. The latter arrangement eliminates the use of excess electrolyte and protective material, and reduces the size of the sensing element by eliminating layers. Any shape can be used for the porous inserts, with the size and geometry of the various inserts, and therefore the corresponding openings, being dependent upon the desired size and geometry of the adjacent electrodes. The openings, inserts, and electrodes can comprise a substantially compatible geometry such that sufficient exhaust gas access to the electrode(s) is enabled and sufficient ionic transfer through the electrolyte is established. The electrolyte can comprise a thickness of about 500 micrometers, more specifically about 25 micrometers to about 500 micrometers, and even more specifically about 50 micrometers to about 200 micrometers.

The sensing and reference electrodes 12,14 which are exposed to the exhaust gas and a reference gas, respectively during operation, can comprise sufficient porosity to permit diffusion to oxygen molecules therethrough. The sensing and reference electrodes 12, 14 can comprise any catalyst capable of ionizing oxygen including, but not limited to, materials such as platinum, palladium, osmium, rhodium, iridium, gold, ruthenium, zirconium, yttrium, cerium, calcium, aluminum, silicon, and the like, and oxides, mixtures, and alloys comprising at least one of the foregoing catalysts. Other additives such as zirconia may be added to impart beneficial properties such as inhibiting sintering of the catalyst to maintain porosity. The electrodes can be disposed on one of the support layers using various thick and/or thin film techniques. The electrodes can comprise a fired thickness of about 0.1 micrometers, more particularly about 1 micrometer, and still more about 3 micrometers. Electrode durability increases with thickness, but at the cost of decreased sensor sensitivity. Thus, a balance between durability and sensitivity exists and the desired balance may be achieved by controlling the thickness of the metal ink during deposition.

Layer L1 is disposed adjacent to the sensing electrode 12, opposite the electrolyte layer L2. Layer L1 can comprise a material capable of protecting the electrolyte layer L2 from contaminants and/or from mechanical deformation, with a gas exchange region disposed at the sensing end 10s that provides fluid communication between the sensing electrode 12 and the gas to be sensed. For example, layer L1 can comprise a plurality of vias 22 disposed at the sensing end 10s. Layer L1 can comprise any number of vias 22, of any size and/or geometry, provided that the plurality of vias 22 is capable of providing sufficient gas exchange at the sensing electrode 12, without compromising the strength of the layer L1. Because the tools for making round vias can be easier to manufacture, and because geometries with comers (e.g., squares, octagons, hexagons, and/or the like) can create stress risers (leading to subsequent cracking of the layer), it is desirable to utilize round vias 22. Each via 22 can comprise a diameter of about 50 micrometers to about 250 micrometers, more particularly about 100 micrometers to about 200 micrometers, and more particularly still about 150 micrometers. The plurality of vias 22 can be randomly disposed in the layer L1 or they can be disposed in a predetermined pattern substantially corresponding to the size and/or geometry of the sensing electrode 12.

The vias 22 can be formed using, for example, an automated mechanical punch and die machine, and the like. The vias 22 can be punched in the green (unfired) ceramic sheet prior to any printing or other processing. This is in contrast to other sensing elements, in which the gas exchange region is formed by manually cutting openings, and manually inserting a porous ceramic insert into the opening.

The vias 22 can be filled with a porous ceramic material (e.g., such as when it is desired to moderate the exchange of gas), or they can be unfilled (e.g., substantially void of a filling material). The plurality of vias 22 can comprise a porous ceramic material capable of providing fluid communication between the sensing electrode 12 and the gas to be sensed. The porous ceramic material can be formed, for example, from a precursor material made by dispersing about 15 wt. % to about 20 wt. % of an organic binder and about 50 wt. % to about 80 wt. % of a ceramic material in a suitable solvent, based upon the total weight of the precursor composition. Possible ceramic materials include, but are not limited to, spinel, alumina, zirconia, and/or the like, and combinations comprising at least one of the foregoing. Optionally, the precursor material can comprise about 0.1 wt. % to about 15 wt. % of a fugitive material, to form pores in the ceramic material. As used herein, “fugitive material” means a material that will occupy space until fired. Possible fugitive materials comprise graphite, carbon black, starch, nylon, polystyrene, latex, other soluble organics (e.g., sugars and the like) and the like, as well as compositions comprising one or more of the foregoing. When a fugitive material is utilized, it can be added to the precursor material in particulate form, with the particles comprising a diameter of about 0.02 micrometers to about 0.2 micrometers. Compositions that contain a fugitive material can create uniform or nearly uniform pores during sintering to maintain gas permeability.

If it is desired to leave the vias 22 empty, then plurality of vias 22 can be filled with a precursor material formed, for example, by dispersing one of the fugitive materials listed above in a suitable solvent. The precursor can be applied prior to lamination and/or firing in order to prevent the plurality of vias 22 from being damaged and/or collapsing during the lamination and/or firing process.

To fill the plurality of vias 22, the precursor material can be applied to one or both sides of layer L1 using a thick film technique such as screen printing, stencil printing, roller coating, and/or a via fill machine. The application of the precursor material will fill the vias, and also deposit a layer of the precursor material corresponding in size to the opening in the screen, stencil, etc., on one or both sides of layer L1, depending on whether one or both sides of the layer were printed. When the precursor material is a porous ceramic precursor material, it can comprise a thickness of about 1 to about 1.5 times the thickness of layer L1, and can overlap the region defined by the plurality of vias by about 0.5 millimeters to about 2.5 millimeters, more particularly about 0.5 millimeters to about 1.5 millimeters.

After filling the vias 22 with the precursor material, layer L1 can be heated to sinter the precursor material (e.g., for about 2 hours at about 1500° C.). The fired porous ceramic material can comprise a porosity of about 5% to about 50%, more particularly about 10% to about 30%. The fired ceramic precursor material forms porous ceramic material regions 22a disposed in the plurality of vias 22. The porous ceramic material regions 22a are continuous with the layer L1, i.e., there are no gaps between the dielectric material of the layer L1 and the porous ceramic material 22a. This is in contrast to other sensing elements comprising porous ceramic tape inserts in layer L1, which can comprise gaps between the porous ceramic inserts and the dielectric layer and/or regions where the porous ceramic inserts overlap the dielectric layer.

The fired precursor material also forms porous ceramic material layers 22b,c disposed on one or both sides of the layer L1, adjacent to the sensing electrode 12. The porous ceramic material regions 22b,c can overlap the sensing electrode by about 0.5 millimeters to about 2.5 millimeters, more particularly about 0.5 millimeters to about 1.5 millimeters.

Optionally, a protective coating (not illustrated) can be disposed over at least the porous ceramic material regions 22a of layer L1, adjacent to the sensing electrode 12. Possible materials for the protective coating can comprise spinel, alumina, and/or stabilized alumina, and the like.

Leads 12a, 14a supply current to the electrodes 12, 14, and extend from electrodes 12,14 respectively, to the terminal end 10t of the sensing element 10 where they are in electrical communication with corresponding vias 30 and contact pads 32. Similarly, leads 20a supply current to the heater 20, and extend from the heater 20 to the terminal end 10t of the sensing element 10 where they are in electrical communication with corresponding vias 18 and contact pads 20. Leads 12a, 14a and 20a can be formed on the same layers as the electrodes and heater with which they are in electrical communication, as they are in the present exemplary embodiment. The electrode leads 12a, 14a and the vias 18 in the insulating and/or electrolyte layers can be formed separately from or simultaneously with electrodes the 12,14.

In addition to the foregoing, sensing element 10 can comprise other sensor components (not illustrated) including, but not limited to, ground plane layers(s), support layer(s), additional electrochemical cell(s), lead gettering layer(s), and the like.

The components of sensing element 10 can be formed using various thin and/or thick film techniques. Examples of thin film techniques include, but are not limited to, chemical vapor deposition, electron beam evaporation, sputtering, and others, as well as combinations comprising one or more of the foregoing techniques. Examples thick film techniques that can be utilized include, but are not limited to, coating (including dip coating and slurry coating), die pressing, painting, printing (including ink jet printing, pad printing, and transfer printing), punching and placing, roll compaction, spinning, spraying (including electrostatic spraying, flame spraying, plasma spraying and slurry spraying), tape casting, and others, as well as combinations comprising one or more of the foregoing.

Electrode, electrolyte, fugitive and porous ceramic material precursor compositions can be prepared by dispersing selected materials in a suitable organic vehicle. The compositions can be formulated as paste, slurry, ink, depending on the application.

Formation of the sensing element can comprise forming the electrolytic cell by disposing the sensing electrode and the reference electrode on opposite sides of the electrolyte layer, optionally forming a gas reference channel on one insulating layer opposite the reference electrode, optionally forming a heater on an insulating layer opposite the gas reference channel, and forming a protective cover adjacent to the sensing electrode. If a co-firing process is used for the formation of the sensor, screen-printing the electrodes onto appropriate tapes enhances simplicity, economy and compatibility with the co-firing process.

Optionally, a green sensing element can be formed prior to sintering the green sheets. Forming a green sensing element can comprise stacking the individual green sheets in an arrangement based on the particular type of sensor being formed. Then, the stacked green sheets can be laminated with heat and under pressure to create a green sensing element.

Also optionally, a laminated stack or “tile” that contains multiple sensing elements can be formed prior to calcining the green sheets. Forming a tile can comprise stacking, aligning, and heat treating additional layers to form laminated stacks that contain the multiple sensing elements. Alternatively, the green sheets can be calcined individually.

Calcining the green sheets, green sensing element, and/or the tiles can comprise heating the same at a sufficient temperature and for a sufficient period of time to calcine the green sheets. For example, the green sheets can be sintered at about 1,475° C. to about 1,550° C., more particularly about 1,490° C. to about 1,510° C. for a period of time of up to about 3 hours, and still more particularly for a period of time of about 100 to about 140 minutes. It should be understood that all firing times and temperatures are only exemplary, and can be varied depending on a variety of factors.

After sintering, the sensing element can be assembled in a suitable package for testing, or it can be disposed in a housing to form a gas sensor. Although the sensor can be used in various applications, including factories and the like, it is particularly useful in vehicle exhaust systems, such as heavy or light-duty diesel truck and gasoline engine applications.

Sensors comprising the foregoing gas exchange region can comprise several improved characteristics such as: (1) formation of the vias on automatic, existing equipment; (2) elimination of manually cutting of a window in the protective layer; (3) elimination of the debris associated with the cutting step; (4) elimination of failures resulting from the debris becoming laminated into the finished sensing element; (5) elimination of manual alignment of the porous ceramic inserts and the windows; (6) and (6) the ability to utilize the process and design on other planar exhaust gas sensors by varying the formulations to match the materials utilized in a particular sensor.

While preferred embodiments have been shown and described, various modifications and substitutions may be made thereto without departing from the spirit and scope of the invention. Accordingly, it is to be understood that the present invention has been described by way of illustration only, and such illustrations and embodiments as have been disclosed herein are not to be construed as limiting to the claims.

What is claimed is:

1. A sensing element comprising:
a sensing electrode;
a reference electrode; and
an electrolyte disposed between and in ionic communication with the sensing electrode and the reference electrode;
a protective layer disposed adjacent to the sensing electrode; and
a plurality of vias disposed in the protective layer adjacent to the electrolyte and in fluid communication with the sensing electrode and a gas to be sensed, wherein each of the vias comprises a diameter of about 50 micrometers to about 250 micrometers.

2. The sensing element of claim 1, further comprising a region of porous ceramic material disposed in each of the plurality of vias.

3. The sensing element of claim 2, wherein the protective layer comprises a first side adjacent to the sensing electrode and a second side opposite the first side, and further comprising a layer of porous ceramic material disposed at the protective layer adjacent to the sensing electrode.

4. The sensing element of claim 3, further comprising a layer of porous ceramic material disposed at the second side of the protective layer adjacent to the sensing electrode.

5. The sensing element of claim 2, wherein the porous ceramic material comprises a ceramic material selected from the group consisting of spinel, alumina, zirconia, and combinations comprising at least one of the foregoing.

6. The sensing element of claim 1, wherein the plurality of vias are substantially aligned with the sensing electrode.

7. A method of forming a sensing element comprising:
disposing an electrolyte between and in ionic communication with a sensing electrode and a reference electrode;
forming a plurality of vias in an unfired protective layer and disposing the plurality of vias adjacent to and in fluid communication with the sensing electrode, each of the vias comprising a diameter of about 50 micrometers to about 250 micrometers; and
heating for a sufficient time and at a sufficient temperature to form the sensing element.

8. The method of claim 7, further comprising disposing a region of porous ceramic material in each of the plurality of vias.

9. The method of claim 8, wherein the protective layer comprises a first side adjacent to the sensing electrode and a second side opposite the first side, and further comprising disposing a layer of porous ceramic material at the protective layer adjacent to the sensing electrode.

10. The method of claim 9, further comprising disposing a layer of porous ceramic material at the second side of the protective layer adjacent to the sensing electrode.

11. The method of claim 8, wherein the porous ceramic material comprises a ceramic material selected from the group consisting of spinel, alumina, zirconia, and combinations comprising at least one of the foregoing.

12. The method of claim 7, further comprising disposing the plurality of vias in substantial alignment with the sensing electrode.
